(19) United States
(12) Patent Application Publication
(10) Pub. No.: US 2005/0040574 A1
(43) Pub. Date: Feb. 24, 2005

(54) Pneumatic surface effect damper

(76) Inventors: Douglas E. Ivers, Cary, NC (US); Robert Wayne Hunter JR., Wake Forest, NC (US)

Correspondence Address: LORD CORPORATION;PATENT & LEGAL SERVICES, 111 LORD DRIVE, CARY, NC, 27512, US

(21) Appl. No.: 10/643,371

(22) Filed: Aug. 19, 2003

(51) Int. Cl. F16F 5/00; F16F 9/00

(52) U.S. Cl. 267/113

(57) ABSTRACT

A pneumatic endstop surface effect damper including an air piston housing with an air piston movable in an up stroke first direction and an opposite down stroke second direction inside the air piston housing and along the air piston inner housing wall with the air piston dividing the inner chamber into a first upper variable volume chamber and a second lower variable volume chamber. The air piston includes a lubricated viscous elastomer surface effect damper which engages the inner wall and provides a surface effect damping of the piston moving along the inner wall with the air piston including a movable valve system actuated by a change in the stroke direction of the air piston with the movable valve system releasing an air pressure from the upper variable volume chamber when the piston changes from the up stroke first direction to the opposite down stroke direction and releases an air pressure from the lower variable volume chamber when the piston changes from the down stroke direction to the up stroke direction, and provides velocity dependent forces.

### FIELD OF THE INVENTION

The present invention relates to a damper for avoiding endstop collisions. More particularly the invention relates to a pneumatic surface effect damper for controlling motion of a suspended body and avoiding suspension endstop collisions and a method of making a pneumatic endstop surface effect damper.

### BACKGROUND OF THE INVENTION

There is a need for an effective and economical means for damping suspension motion and avoiding end stop collisions. There is a need for an economically feasible damper that avoids end stops collisions and provides improved dampening performance that that is velocity and position dependent. There is a need for a robust damper system and method of making a pneumatic endstop surface effect damper. There is a need for an economic mechanical motion controlling damper that avoids endstop collisions and provides an improved controlled damping force related travel speed and position without the use of electronic control systems or control policies.

### SUMMARY OF THE INVENTION

The invention includes a pneumatic endstop surface effect damper that provides damping in both the up stroke direction and the down stroke direction and utilizes a pneumatic air piston and surface effect damping from viscous working of an elastomer between rigid members to avoid end stop collisions.

The invention includes a pneumatic endstop surface effect damper. The pneumatic endstop surface effect damper includes an air piston housing with an air piston housing wall defining an air piston inner chamber and an air piston movable in an up stroke first direction and an opposite down stroke second direction inside the air piston housing. The air piston divides the air piston inner chamber into a first upper variable volume chamber and a second lower variable volume chamber. The air piston including a lubricated viscous elastomer surface effect damper which engages the inner wall and provides a surface effect damping of the piston moving along the inner wall. The air piston includes a movable valve system actuated by a change in the stroke direction of the air piston wherein the movable valve system releases an air pressure from the upper variable volume chamber when the piston changes from the up stroke first direction to the opposite down stroke direction and releases an air pressure from the lower variable volume chamber when the piston changes from the down stroke direction to the up stroke direction.

The invention includes a pneumatic endstop surface effect damper having a piston housing with an inner housing wall defining an inner chamber. The pneumatic piston is movable in a first direction stroke and an opposite second direction stroke inside the piston housing and along the inner housing wall with the piston dividing the piston housing inner chamber into a first variable volume chamber and a second variable volume chamber. The piston includes an elastomer surface effect damper which engages the inner wall and provides a surface effect damping of the piston moving along the inner wall, the piston including a movable valve system actuated by a change in the stroke direction of the piston wherein the movable valve system releases a builtup pneumatic pressure from the first variable volume chamber when the piston changes from the first direction stroke to the opposite second direction stroke and releases a builtup pneumatic pressure from the second variable volume chamber when the piston changes from the second direction stroke to the first direction stroke.

The invention includes a pneumatic endstop surface effect damper having a piston housing with an inner housing wall defining an inner chamber. The damper includes a pneumatic piston movable in a first direction stroke and an opposite second direction stroke inside the piston housing and along the inner housing wall with the piston dividing the piston housing inner chamber into a first variable volume chamber and a second variable volume chamber. The piston includes an elastomer surface effect damper which engages the inner wall and provides a surface effect damping of the piston moving along the inner wall. The piston includes a constant volume accumulator chamber and a movable valve system actuated by a change in the stroke direction of the piston wherein the movable valve system provides for a pneumatic flow from the first variable volume chamber into the accumulator chamber when the piston moves in the first direction and releases a builtup pneumatic pressure from the first variable volume chamber. When the piston changes from the first direction stroke to the opposite second direction stroke, the movable valve system provides for a pneumatic flow from the second variable volume chamber into the accumulator chamber when the piston moves in the second direction and releases a builtup pneumatic pressure from the second variable volume chamber when the piston changes from the second direction stroke to the first direction stroke.

The invention includes a pneumatic endstop surface effect damper comprised of a piston housing with an inner housing wall defining an inner chamber, a rigid pneumatic piston movable in a first direction stroke and an opposite second direction stroke inside the piston housing and along the inner housing wall, the piston dividing the piston housing inner chamber into a first variable volume chamber and a second variable volume chamber, with the piston including a movable valve system actuated by a change in the stroke direction of the piston wherein the movable valve system releases a builtup pneumatic pressure from the first variable volume chamber when the piston changes from the first direction stroke to the opposite second direction stroke and releases a builtup pneumatic pressure from the second variable volume chamber when the piston changes from the second direction stroke to the first direction stroke, the damper including a surface effect damper elastomeric member between the piston housing inner wall and the pneumatic piston which inhibits movement of the piston along the wall with a surface effect damping of the piston motion along the inner wall utilizing a elastomeric surface effect damping force with viscous working of the elastomer between the rigid wall and the rigid piston.

The invention includes a method of making a pneumatic endstop surface effect damper. The method includes providing a piston housing with an inner housing wall defining an inner chamber, providing a rigid pneumatic piston for dividing the piston housing inner chamber into a first variable volume chamber and a second variable volume chamber, providing a pneumatic piston valve system for controlling the pneumatic flow of a gas through the pneumatic piston, and providing a surface effect damper elastomeric member for damping a relative motion between the piston housing and the rigid pneumatic piston. The method includes assembling the rigid pneumatic piston, the pneumatic piston valve, and the surface effect damper elastomeric member into the piston housing inner chamber wherein the rigid pneumatic piston is movable in a first direction stroke and an opposite second direction stroke inside the piston housing and along the inner housing wall, the piston dividing the piston housing inner chamber into a first variable volume chamber and a second variable volume chamber with the pneumatic piston valve system actuated by a change in the stroke direction of the piston wherein the valve system releases a builtup pneumatic pressure from the first variable volume chamber when the piston changes from the first direction stroke to the opposite second direction stroke and releases a builtup pneumatic pressure from the second variable volume chamber when the piston changes from the second direction stroke to the first direction stroke, and with the surface effect damper elastomeric member positioned between the piston housing wall and the pneumatic piston to inhibit movement of the piston along the housing wall with a surface effect damping force.

The invention includes the methods of using the pneumatic endstop surface effect damper to control motion and avoid endstop collisions.

It is to be understood that both the foregoing general description and the following detailed description are exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principals and operation of the invention.

### BRIEF DESCRIPTION OF THE DRAWINGS

FIG. 1A-C show an embodiment of the invention.

FIG. 2A-C show an embodiment of the invention.

FIG. 3 shows an embodiment of the invention.

FIG. 4 shows an embodiment of the invention.

### DETAILED DESCRIPTION OF THE PREFERRED EMBODIMENT

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

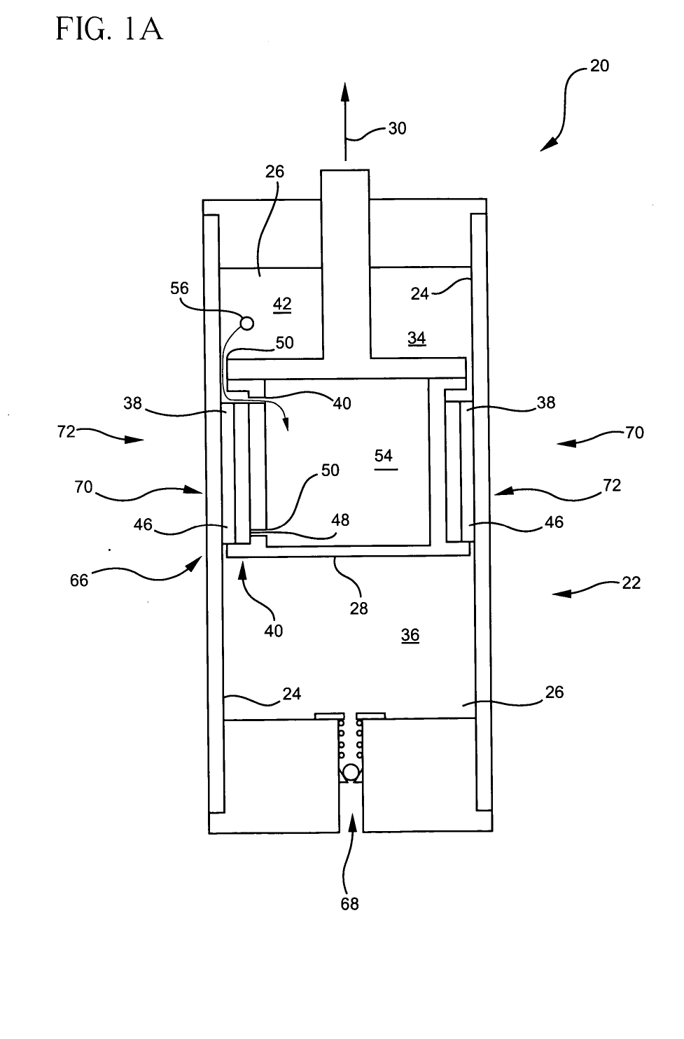

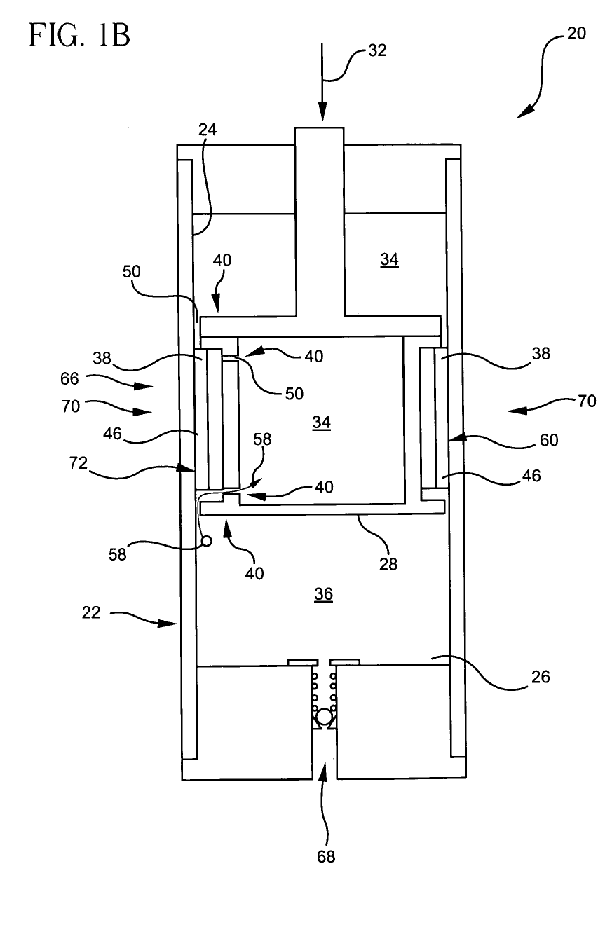

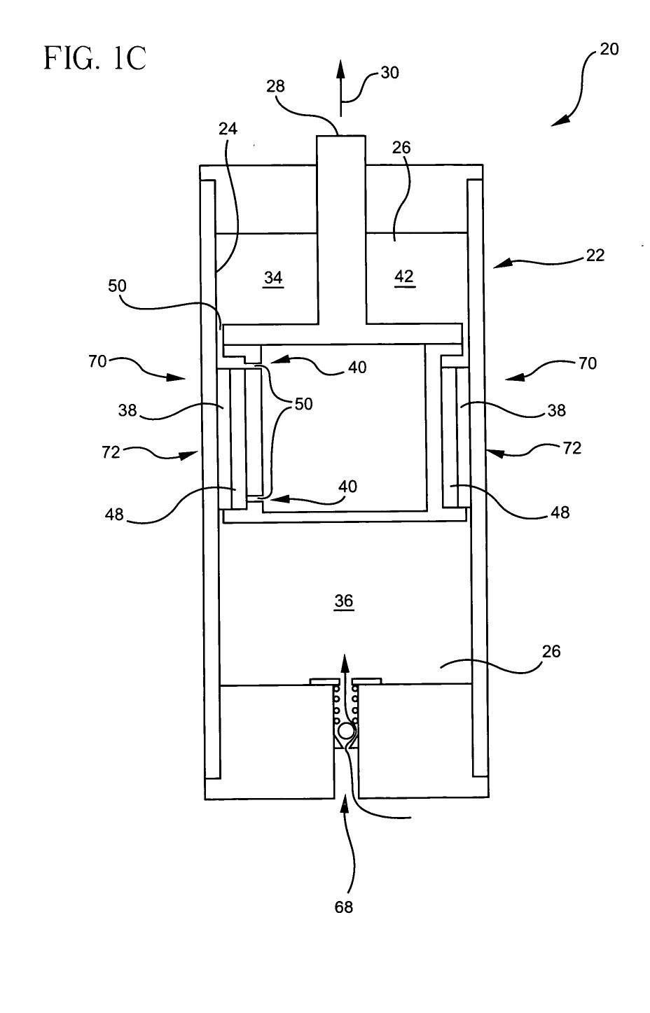

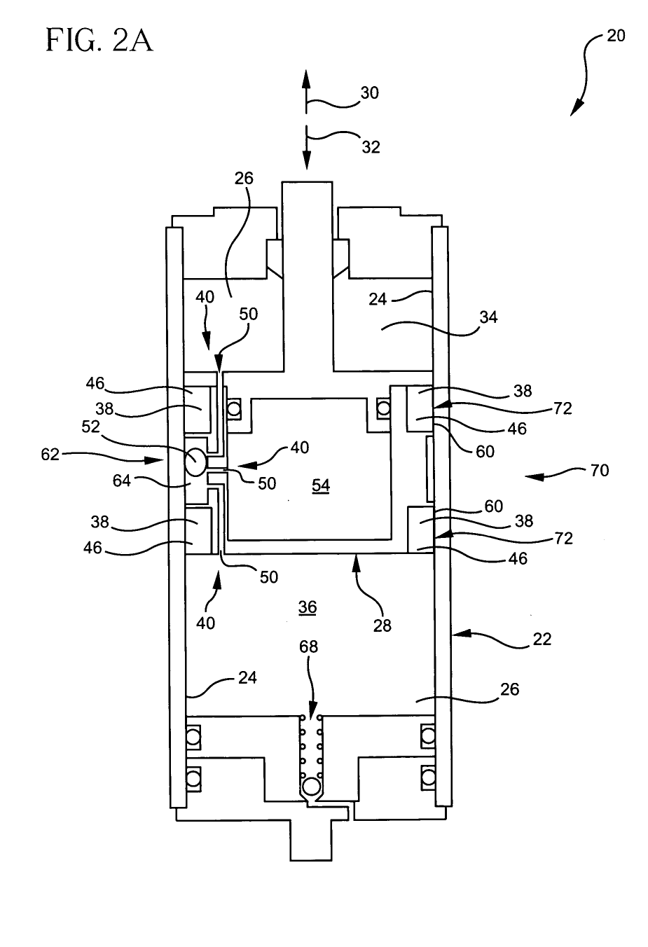

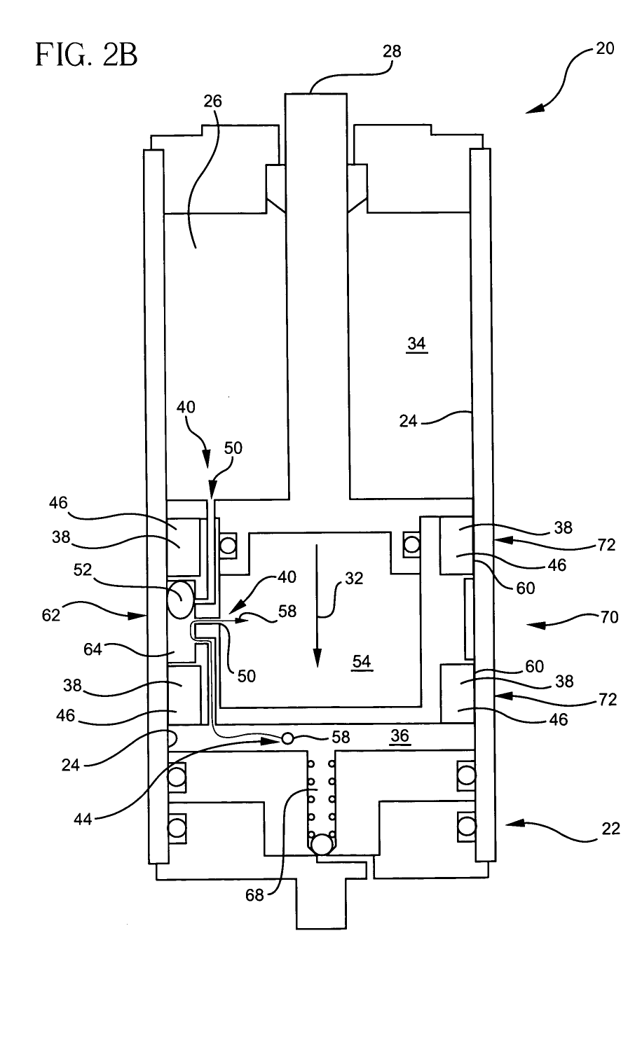

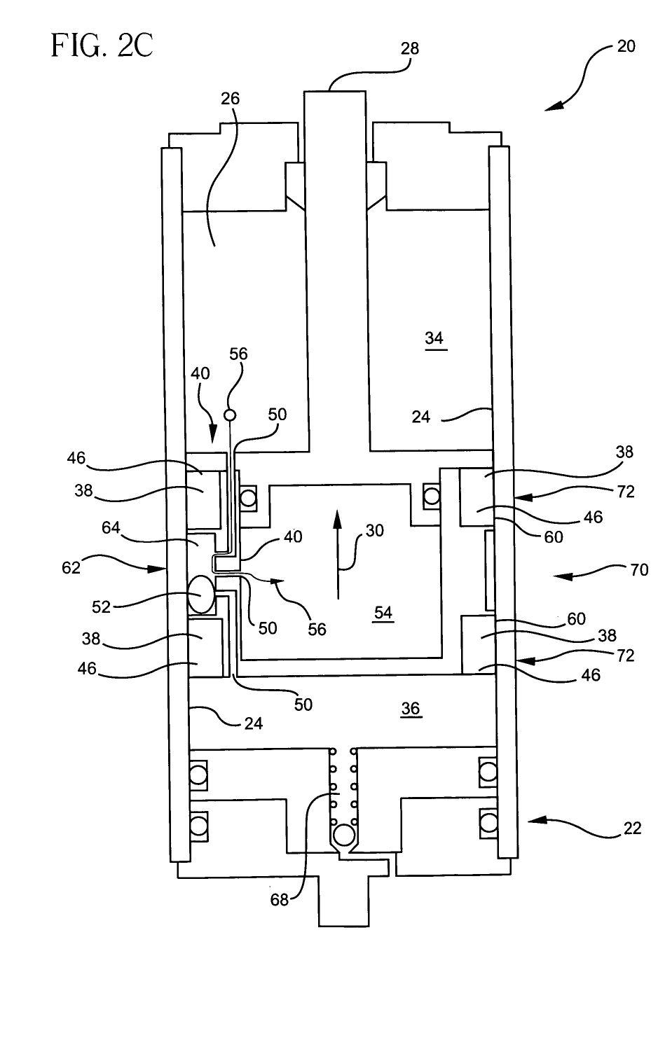

Reference will now be made in detail to the present preferred embodiments of the invention, examples of which are illustrated in the accompanying drawings. The invention includes a pneumatic endstop surface effect damper 20. The pneumatic endstop surface effect damper 20 is comprised of an air piston housing 22 with an air piston inner housing wall 24 defining an air piston inner chamber 26. The damper includes an air piston 28 movable in an up stroke first direction 30 and an opposite down stroke second direction 32 inside the air piston housing 22 and along the air piston inner housing wall 24. The air piston 28 divides the air piston inner chamber 26 into a first upper variable volume chamber 34 and a second lower variable volume chamber 36. The air piston includes a lubricated viscous elastomer surface effect damper 38 which engages the inner wall 24 and provides a surface effect damping of the piston 28 moving along the inner wall 24. Preferably the lubricated viscous elastomer surface effect damper 38 is a resilient elastomeric band member that encompasses the diameter of the piston 28. As shown in FIG. 1 the lubricated viscous elastomer surface effect damper 38 is a single resilient elastomeric band member that encircles the piston outer peripheral diameter and substantially covers the majority of the piston 28 outer peripheral diameter side surface area adjacent to the wall 24, providing a preferred high level of surface effect damping between the rigid piston and the rigid housing. As shown in FIG. 2 the lubricated viscous elastomer surface effect damper 38 are comprised of two resilient elastomeric band member that encircle a lower portion and an upper portion of the piston 28 outer peripheral diameter side surface area adjacent to the wall 24. The surface effect damping of the resilent elastomer includes a combination of friction, viscous and hysteretic damping components resulting from the working and deformation of the elastomer between the rigid piston and the rigid housing. The air piston 28 includes a movable valve system 40 actuated by a change in the stroke directions 30 and 32 of the air piston wherein the movable valve system 40 releases an air pressure 42 from the upper variable volume chamber 34 when the piston changes from the up stroke first direction 30 to the opposite down stroke direction 32 and releases an air pressure 44 from the lower variable volume chamber 36 when the piston 28 changes from the down stroke direction 32 to the up stroke direction 30. As shown in FIG. 1 the movable valve system 40 is comprised of the lubricated viscous elastomer surface effect damper 38 with the elastomeric damper band 46 and its nonelastomeric band backer 48 sliding between the piston 28 and the wall 24 to open and close air channel orifices 50 that provide a valved communication between upper chamber 34 and lower chamber 36 through piston 28. As shown in FIG. 2 the movable valve system 40 is comprised of the elastomer seal ball 52 that rolls between the piston 28 and the wall 24 to open and close air channel orifices 50 that provide a valved communication between upper chamber 34 and lower chamber 36 through piston 28, with the ball 52 movably opening and closing the valve system air channel orifices when the stroke direction changes. The damper 20 is position and velocity dependent and avoids endstop collisions with the pneumatic resistance of the gas contained in the chambers 34 and 36, by using transient pressure feedback to define pneumatic flow between the constant volume chamber and the variable volume chambers. The compression of the air by the piston in the chamber provides a nonlinear resistive force that provides a position dependence near the end of travel of the piston in the housing to avoid endstop collisions. The valve system 40 release of builtup pressure with a change in the stroke directions 30 and 32 provides for beneficial potential energy dissipation by the damper 20 by releasing the energy stored in the damper by the compression of the gas in the variable volume chamber 34, 36 that is being compressed by the piston 28.

Preferably the damper air piston 28 includes a constant volume accumulator chamber 54 with the movable valve system 40 providing an air flow 56 from the upper variable volume chamber 34 into the accumulator chamber 54 when the air piston 26 moves in the up stroke first direction 30, and the movable valve system 40 provides for an air flow 58 from the lower variable volume chamber 36 into the accumulator chamber 54 when the air piston 26 moves in the opposite down stroke direction 32. The accumulator chamber 54 provides a preferred velocity dependence to maintain a beneficial deceleration force.

In an embodiment the lubricated viscous elastomer surface effect damper 38 is comprised of a self-lubricating elastomeric material. In an embodiment the lubricated viscous elastomer surface effect damper 38 is comprised of a greased elastomeric surface 60.

In an embodiment the movable valve system 40 is comprised of a rolling ball valve 62 with elastomer ball 52 that rolls between piston 28 and wall 24 in a valve conduit 64. As shown in FIG. 2 the rolling ball valve 62 provides for the air flow into constant volume accumulator 54 from a variable volume chamber (34, 36) that the piston is moving into, and allows the release of builtup pressure from that reduced volume chamber when the piston travel changes to the other direction, and then allows for the air flow into constant volume accumulator 54 from the opposing variable volume chamber (34, 36) that the piston is now moving into.

In an embodiment the movable valve system 40 is comprised of a slide valve 66. The slide valve 66 slides between piston 28 and wall 24 to open the connecting air channel orifices 50 to provide for the air flow into constant volume accumulator 54 from a variable volume chamber (34, 36) that the piston is moving into, and allows the release of builtup pressure from that reduced volume chamber when the piston travel changes to the other direction, and then allows for the air flow into constant volume accumulator 54 from the opposing variable volume chamber (34, 36) that the piston is now moving into. Preferably the slide valve 66 is comprised of damper band elastomer slider 46, with the surface effect damper elastomer slider 46 bonded and integrated to a nonelastomer damper band backer slider 48. With such a preferred embodiment the surface effect damper is the slide valve. Preferably the backer slider 48 is a plastic backer with a smooth sliding interface surface with piston 28, with the sliding force of backer 48 interface with piston head sides less than interface sliding force between surface effect elastomer surface 60 and inner housing wall 24, such as the piston being smooth aluminum and the backer smooth plastic. Preferably the lubricated viscous elastomer surface effect damper 38 is the slide valve 66 so that the surface effect elastomeric body provides for damping the relative motion between the housing and the piston and sliding valving based on the direction of travel of the piston 28 relative to the housing 22.

Preferably the movable valve system 40 is comprised of an elastomeric mover that engages the inner wall 24. In FIG. 1 the elastomeric mover of valve system 24 is elastomeric damper band 46 moves and slides between the piston 28 and inner wall 24 with the slider valve being the lubricated viscous elastomer surface effect damper. With such a preferred embodiment of FIG. 1 the lubricated viscous elastomer surface effect damper comprises the movable valve system elastomeric mover, thus utilizing a dual function elastomeric mover and surface effect damper. Preferably the surface effect damper is part of the valve system. In FIG. 2 the elastomeric mover of valve system 24 is elastomeric ball 52 that moves and rolls between the piston 28 and inner wall 24. With the embodiment of FIG. 2 the movable valve system elastomeric mover is preferably separate from the lubricated viscous elastomer surface effect damper, with the ball 52 separated from and independent from the surface effect damper, such that the surface effect damper 38 is not part of valve system 40.

In an embodiment of the damper 20 the air piston housing includes an air intake check valve 68 for providing an inflow of atmospheric air into the air piston inner chamber 26. As shown in FIG. 1-2 the air intake check valve 68 is a one way valve that allows air flow into lower chamber 36 during an upstroke 30 when the atmospheric pressure surrounding the damper 20 is greater than the air pressure of the lower chamber 36. Preferably the air intake check valve 68 provides for the input of air into the damper so that the damper can adapt to a rigorous use environment by drawing air gas molecules into the damper system during an upstroke so as to charge the damper with more gas molecules to work with. The air intake check valve 68 provides for the pumping up of the air gas molecule count in the piston chamber 26 utilizing the relative vacuum formed in the lower chamber 36 during a drastic upstroke 30, with the higher air gas molecule count allowing the damper to produce higher damping forces and the damper 20 to adapt to a harsher use environment. During times of low input energy, the damper internal pressure will slowly approach surrounding atmospheric pressure because of slight leaking of seals.

Preferably the air piston 28 has an air piston engagement area 70 with the inner wall 24 and the elastomer surface effect damper 38 having a surface effect engagement area 72 at its surface interface 60 with the inner wall 24 with the surface effect engagement area 72 at least fifty percent of the air piston engagement area 70. Preferably the surface effect engagement area 72 is at least sixty percent of the air piston engagement area 70, more preferably at least seventy percent of the air piston engagement area, more preferably at least eighty percent of the air piston engagement area, and most preferably at least ninety percent of the air piston engagement area.

As shown in FIG. 1-2 the air piston inner chamber 26 has a uniform diameter, preferably with the air piston inner housing wall and air piston inner chamber 26 having a uniform cylindrical shape. The damper 20 is comprised of a uniform interior diameter with damping in both the up and down stroke direction.

The pneumatic endstop surface effect damper 20 is comprised of a piston housing 22 with an inner housing wall 24 defining an inner chamber 26 and a pneumatic piston 28 movable in a first direction stroke 30 and an opposite second direction stroke 32 inside the piston housing 22 and along the inner housing wall 24, with the piston 28 dividing the piston housing inner chamber 26 into a first variable volume chamber 34 and a second variable volume chamber 36, with the piston including an elastomer surface effect damper 38 which engages the inner wall 24 and provides a surface effect damping of the piston 28 moving along the inner wall 24. The piston 28 includes a movable valve system 40 actuated by a change in the stroke direction of the piston 28 wherein the movable valve system 40 releases a builtup pneumatic pressure 42 from the first variable volume chamber 34 when the piston changes from the first direction stroke 30 to the opposite second direction stroke 32 and releases a builtup pneumatic pressure 44 from the second variable volume chamber 36 when the piston changes from the second direction stroke 32 to the first direction stroke 30. Preferably the piston 28 includes a constant volume accumulator chamber 54 wherein the movable valve system 40 provides for a pneumatic flow 56 from the first variable volume chamber 34 into the accumulator chamber when the piston moves in the first direction 30, and the movable valve system 40 provides for a pneumatic flow 58 from the second variable volume chamber 36 into the accumulator chamber 54 when the piston 28 moves in the opposite second direction 32. In an embodiment such as shown in FIG. 2 the movable valve system 40 is comprised of a rolling ball valve 62, with an elastomer ball 52 that rolls between piston 28 and wall 24 in a valve conduit 64. In an embodiment such as shown in FIG. 1 the movable valve system 40 is comprised of a slide valve 66, preferably with an elastomer slider 46 bonded and integrated to a nonelastomer slider backer 48, such as a plastic backer with a smooth sliding interface with piston 28, with the sliding force of the backer interface with piston sides less than the interface sliding force between surface effect elastomer surface 60 and inner housing wall 24, preferably with the lubricated viscous elastomer surface effect damper 38 being the slide valve 66. Preferably the movable valve system 40 is comprised of an elastomeric mover that engages the inner wall 24, such as the ball 52 in FIG. 2 or damper band slider 46. Preferably the slider mover of valve system 40 is the lubricated viscous elastomer surface effect damper 38, with the surface effect damper 38 providing both a valving function and a damping function. Preferably the elastomer surface effect damper 38 is comprised of a lubricated elastomeric material. In embodiments as shown in FIG. 1-2 the piston housing includes an intake check valve 68 for providing an inflow of gas molecules into the piston inner chamber 26, with the one way valve allowing gas flow into lower chamber 36 during an upstroke 30 when the gas pressure on the other side of the check valve is greater than the gas pressure of the lower chamber. Preferably the piston 28 has an piston engagement area 70 with the inner wall 24 and the elastomer surface effect damper 38 having a surface effect engagement area 72 at its surface interface 60 with the inner wall 24 with the surface effect engagement area 72 at least fifty percent of the piston engagement area 70. Preferably the surface effect engagement area 72 is at least sixty percent of the piston engagement area 70, more preferably at least seventy percent of the piston engagement area, more preferably at least eighty percent of the piston engagement area, and most preferably at least ninety percent of the piston engagement area. Preferably the damper housing chamber 26 has a uniform interior diameter along its longitudinal length from the upper chamber end cap to the lower chamber end cap.

The pneumatic endstop surface effect damper 20 is comprised of a piston housing 22 with an inner housing wall 24 defining an inner chamber 26, and a pneumatic piston 28 movable in a first direction stroke 30 and an opposite second direction stroke 32 inside the piston housing 22 and along the inner housing wall 24 with the piston 28 dividing the piston housing inner chamber 26 into a first variable volume chamber 34 and a second variable volume chamber 36. The piston 28 includes an elastomer surface effect damper 38 which engages the inner wall 24 and provides a surface effect damping of the piston moving along the inner wall. The piston 28 includes a constant volume accumulator chamber 54 and a movable valve system 40 actuated by a change in the stroke direction of the piston wherein the movable valve system 40 provides for a pneumatic flow 56 from the first variable volume chamber 34 into the accumulator chamber 54 when the piston moves in the first direction 30 and releases a builtup pneumatic pressure 42 from the first variable volume chamber 34 when the piston 28 changes from the first direction stroke 30 to the opposite second direction stroke 32, and provides for a pneumatic flow 58 from the second variable volume chamber 36 into the accumulator chamber 54 when the piston 28 moves in the second direction 32 and releases a builtup pneumatic pressure 44 from the second variable volume chamber36 when the piston 28 changes from the second direction stroke 32 to the first direction stroke 30. Preferably the elastomer surface effect damper 38 is comprised of a lubricated elastomeric material. In an embodiment such as shown in FIG. 2 the valve system 40 is comprised of a rolling ball valve 62 with an elastomer ball that rolls between piston 28 and wall 24 in a valve conduit which opens and closes communication between chambers 34, 54, and 36. In an embodiment such as shown in FIG. 1 the valve system 40 is comprised of a slide valve 66, preferably an elastomer slider bonded and integrated to a nonelastomer slider backer, such as plastic backer with a smooth sliding interface with piston 28, preferably with the lubricated viscous elastomer surface effect damper 38 being the valve system 40 movable slide valve in a valve conduit which opens and closes communication between chambers 34, 54, and 36. Preferably the valve system 40 is comprised of an elastomeric mover that moves in a valve conduit which opens and closes communication between chambers 34, 54, and 36 based on piston travel and change in direction of piston travel.

The pneumatic endstop surface effect damper 20 is comprised of a piston housing 22 with an inner housing wall 24 defining an inner chamber 26, a rigid pneumatic piston 28 movable in a first direction stroke 30 and an opposite second direction stroke 32 inside the piston housing 22 and along the inner housing wall 24, with the piston 28 dividing the piston housing inner chamber 26 into a first variable volume chamber 34 and a second variable volume chamber 36, with the piston including a movable valve system 40 actuated by a change in the stroke direction of the piston 28 wherein the movable valve system 40 releases a builtup pneumatic pressure 42 from the first variable volume chamber 34 when the piston 28 changes from the first direction stroke 30 to the opposite second direction stroke 32 and releases a builtup pneumatic pressure 44 from the second variable volume chamber 36 when the piston 28 changes from the second direction stroke 32 to the first direction stroke 30, with the damper including a surface effect damper elastomeric member 38 between the piston housing inner wall and the pneumatic piston which inhibits movement of the piston along the wall with a surface effect damping of the piston motion along the inner wall with a elastomeric surface effect damping force from the viscous hysteretic working of the elastomer between the rigid housing wall and the rigid piston 28. As shown in FIG. 1-2 rigid piston 28 preferably includes a constant volume accumulator chamber 54 wherein the movable valve system 40 provides for a pneumatic flow 56 from the first variable volume chamber 34 into the accumulator chamber 54 when the piston 28 moves in the first direction 30, and the movable valve system 40 provides for a pneumatic flow 58 from the second variable volume chamber 36 into the accumulator chamber 54 when the piston 28 moves in the opposite second direction 32.

The invention includes the method of making pneumatic endstop surface effect dampers 20 and the method of using a pneumatic endstop surface effect dampers 20 to dampen motion. The method of making a pneumatic endstop surface effect damper 20 includes providing a piston housing 22 with an inner housing wall 24 defining an inner chamber 26, providing a rigid pneumatic piston 28 for dividing the piston housing inner chamber 26 into a first variable volume chamber 34 and a second variable volume chamber 36, providing a pneumatic piston valve system 40 for controlling the pneumatic flow of a gas through the pneumatic piston, providing a surface effect damper elastomeric member 38 for damping a relative motion between the piston housing and the rigid pneumatic piston, assembling the rigid pneumatic piston 28, the pneumatic piston valve system 40, and the surface effect damper elastomeric member 38 into the piston housing inner chamber 26 wherein the rigid pneumatic piston 28 is movable in a first direction stroke 30 and an opposite second direction stroke 32 inside the piston housing 22 and along the inner housing wall 24, with the piston 28 dividing the piston housing inner chamber 26 into a first variable volume chamber 34 and a second variable volume chamber 36 with the pneumatic piston valve system 40 actuated by a change in the stroke direction of the piston 28 wherein the valve system 40 releases a builtup pneumatic pressure 42 from the first variable volume chamber 34 when the piston 28 changes from the first direction stroke 30 to the opposite second direction stroke 32 and releases a builtup pneumatic pressure 44 from the second variable volume chamber 36 when the piston 28 changes from the second direction stroke 32 to the first direction stroke 30, and with the surface effect damper elastomeric member 38 positioned between the piston housing 22 and the pneumatic piston 28 to inhibit movement of the piston 28 along the housing wall 24 with a surface effect damping force.

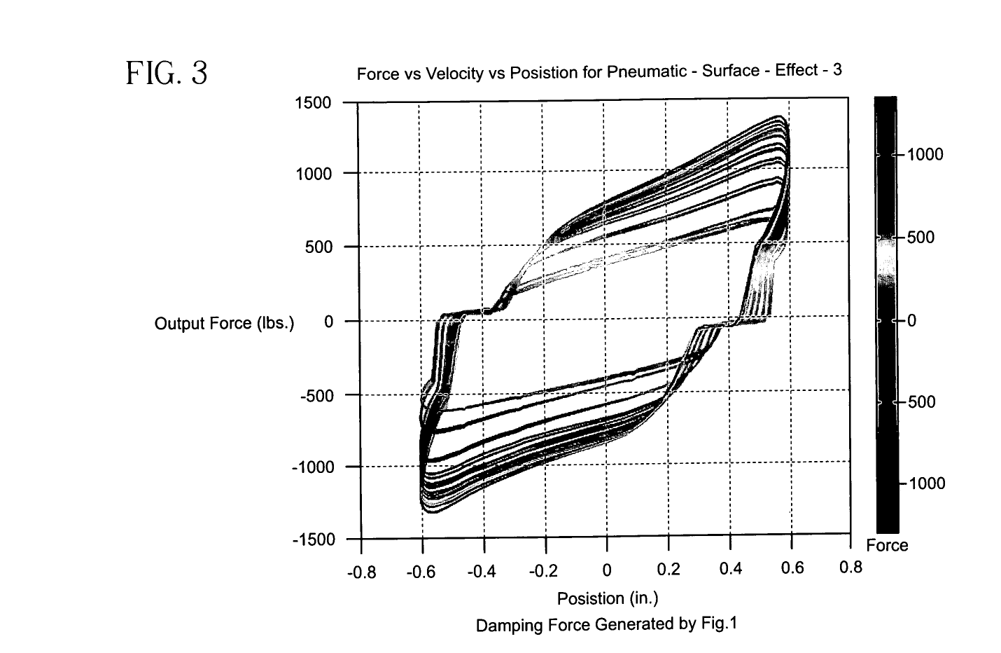

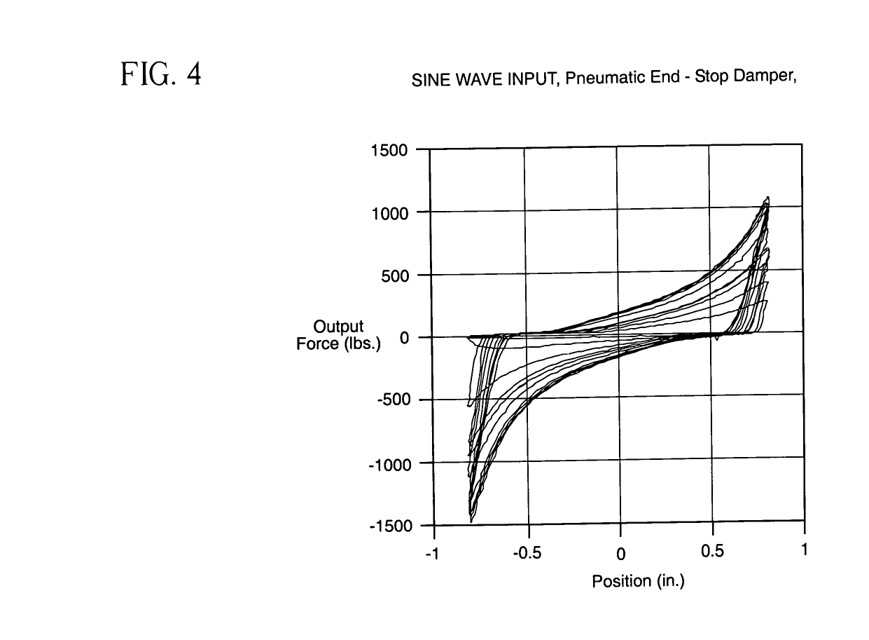

The generated damping force plot of a pneumatic endstop surface effect damper 20 in accordance with the embodiment of FIG. 1 is shown in FIG. 3. The generated damping force plot of a pneumatic endstop surface effect damper 20 in accordance with the embodiment of FIG. 2 is shown in FIG. 4. The invention includes a method of damping motion with the pneumatic endstop surface effect dampers 20. The orifice sizes of air channel orifices 50 for a given pneumatic endstop surface effect dampers 20 can be sized to maximize velocity dependence for the displacement and velocity ranges of interest for using the damper 20. The valve system 40 provides for the pressure drop across the piston 28 to be equalized whenever the direction of motion changes. The surface effect damper 38 provides for damping along the whole travel path of the piston 28 and allows for near midstroke damping. With the embodiment shown in FIG. 2 there is less surface effect force. With the embodiment shown in FIG. 2 the rolling ball valve 62 provides a pressure dump valve, when the piston 28 is moving upward, the ball covers the lower hole of conduit 64, pressure builds in the upper chamber 34 and to a lesser degree, in the accumulator 54, when the piston 28 stops and begins to move downward, the ball 52 moves off the lower hole and the builtup pressure is released into the lower chamber 36. Releasing the built up pressure increases energy dissipation and provides end stop forces. FIG. 4 shows typical force-position-velocity curves for such a pneumatic endstop surface effect damper 20 of FIG. 2. As shown in FIG. 1, the pneumatic endstop surface effect damper embodiment uses a large rubber ring damper band 46 to both create surface effect forces and to dump the pressure when the direction of motion changes. FIG. 3 shows typical force vs. position curves for a range of velocities for this damper. Note that the forces near zero displacement are much higher with this embodiment because of the preferred large surface effect area. As shown in FIG. 3, preferably the damper force returns to 0 within fifteen percent of the total stroke length, preferably the damper force returns from its maximum to zero within ten percent of the total stroke length (position on X-axis in inches). The damper provides damping in both directions of travel, preferably with damping in both directions being substantially the same.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

1. A pneumatic endstop surface effect damper, said pneumatic endstop surface effect damper comprised of an air piston housing with an air piston inner housing wall defining an air piston inner chamber, an air piston movable in an up stroke first direction and an opposite down stroke second direction inside said air piston housing and along said air piston inner housing wall, said air piston dividing said air piston inner chamber into a first upper variable volume chamber and a second lower variable volume chamber, said air piston including a lubricated viscous elastomer surface effect damper which engages said inner wall and provides a surface effect damping of the piston moving axially along said inner wall, said air piston including a movable valve system actuated by a change in the stroke direction of said air piston wherein said movable valve system releases an air pressure from said upper variable volume chamber when said piston changes from said up stroke first direction to said opposite down stroke direction and releases an air pressure from said lower variable volume chamber when said piston changes from said down stroke direction to said up stroke direction.

2. A damper as claimed in claim 1, said air piston including an accumulator chamber wherein said movable valve system provides for an air flow from said upper variable volume chamber into said accumulator chamber when said air piston moves in said up stroke first direction, and said movable valve system provides for an air flow from said lower variable volume chamber into said accumulator chamber when said air piston moves in said opposite down stroke direction.

3. A damper as claimed in claim 1, wherein said lubricated viscous elastomer surface effect damper is comprised of a self-lubricating elastomeric material.

4. A damper as claimed in claim 1, wherein said lubricated viscous elastomer surface effect damper is comprised of a greased elastomeric surface.

5. A damper as claimed in claim 1, wherein said movable valve system is comprised of a rolling ball valve.

6. A damper as claimed in claim 1, wherein said movable valve system is comprised of a slide valve.

7. A damper as claimed in claim 1, wherein said movable valve system is comprised of an elastomeric mover.

8. A damper as claimed in claim 7, wherein said lubricated viscous elastomer surface effect damper comprises said movable valve system elastomeric mover.

9. A damper as claimed in claim 7, wherein said movable valve system elastomeric mover is separate from said lubricated viscous elastomer surface effect damper.

10. A damper as claimed in claim 1, said air piston housing including an air intake check valve for providing an inflow of atmospheric air into said air piston inner chamber.

11. A damper as claimed in claim 1, said air piston having an air piston engagement area with said inner wall and said elastomer surface effect damper having a surface effect engagement area with said inner wall with said surface effect engagement area at least fifty percent of said air piston engagement area.

12. A pneumatic endstop surface effect damper, said pneumatic endstop surface effect damper comprised of a piston housing with an inner housing wall defining an inner chamber, a pneumatic piston movable in a first direction stroke and an opposite second direction stroke inside said piston housing and along said inner housing wall, said piston dividing said piston housing inner chamber into a first variable volume chamber and a second variable volume chamber, said piston including an elastomer surface effect damper which engages said inner wall and provides a surface effect damping of the piston moving axially along said inner wall, said piston including a valve system actuated by a change in the stroke direction of said piston wherein said valve system releases a pneumatic pressure from said first variable volume chamber when said piston changes from said first direction stroke to said opposite second direction stroke and releases a pneumatic pressure from said second variable volume chamber when said piston changes from said second direction stroke to said first direction stroke.

13. A damper as claimed in claim 12, said piston including a constant volume accumulator chamber wherein said valve system provides for a pneumatic flow from said first variable volume chamber into said accumulator chamber when said piston moves in said first direction, and said movable valve system provides for a pneumatic flow from said second variable volume chamber into said accumulator chamber when said piston moves in said opposite second direction.

14. A damper as claimed in claim 12, wherein said elastomer surface effect damper is comprised of a lubricated elastomeric material.

15. A damper as claimed in claim 12, wherein said valve system is comprised of a rolling ball valve.

16. A damper as claimed in claim 12, wherein said valve system is comprised of a slide valve.

17. A damper as claimed in claim 12, wherein said valve system is comprised of an elastomeric mover.

18. A damper as claimed in claim 17, wherein said elastomer surface effect damper comprises said valve system elastomeric mover.

19. A damper as claimed in claim 12, said piston having a piston engagement area with said inner wall and said elastomer surface effect damper having a surface effect engagement area with said inner wall with said surface effect engagement area at least fifty percent of said piston engagement area.

20. A pneumatic endstop surface effect damper, said pneumatic endstop surface effect damper comprised of a piston housing with an inner housing wall defining an inner chamber, a pneumatic piston movable in a first direction stroke and an opposite second direction stroke inside said piston housing and along said inner housing wall, said piston dividing said piston housing inner chamber into a first variable volume chamber and a second variable volume chamber, said piston including an elastomer surface effect damper which engages said inner wall and provides a surface effect damping of the piston moving axially along said inner wall, said piston including a constant volume accumulator chamber and a movable valve system actuated by a change in the stroke direction of said piston wherein said movable valve system provides for a pneumatic flow from said first variable volume chamber into said accumulator chamber when said piston moves in said first direction and releases a pneumatic pressure from said first variable volume chamber when said piston changes from said first direction stroke to said opposite second direction stroke, and provides for a pneumatic flow from said second variable volume chamber into said accumulator chamber when said piston moves in said second direction and releases a pneumatic pressure from said second variable volume chamber when said piston changes from said second direction stroke to said first direction stroke.

21. A damper as claimed in claim 20, wherein said elastomer surface effect damper is comprised of a lubricated elastomeric material.

22. A damper as claimed in claim 20, wherein said valve system is comprised of a rolling ball valve.

23. A damper as claimed in claim 20, wherein said valve system is comprised of a slide valve.

24. A damper as claimed in claim 23, wherein said valve system is comprised of an elastomeric mover.

25. A damper as claimed in claim 24, wherein said elastomer surface effect damper comprises said valve system elastomeric mover.

26. A pneumatic endstop surface effect damper, said pneumatic endstop surface effect damper comprised of a piston housing with an inner housing wall defining an inner chamber, a rigid pneumatic piston movable in a first direction stroke and an opposite second direction stroke inside said piston housing and along said inner housing wall, said piston dividing said piston housing inner chamber into a first variable volume chamber and a second variable volume chamber, said piston including a movable valve system actuated by a change in the stroke direction of said piston wherein said movable valve system releases a pneumatic pressure from said first variable volume chamber when said piston changes from said first direction stroke to said opposite second direction stroke and releases a pneumatic pressure from said second variable volume chamber when said piston changes from said second direction stroke to said first direction stroke, said damper including a surface effect damper elastomeric member between said piston housing and said pneumatic piston which inhibits movement of said piston axially along said wall with a surface effect damping of the piston motion along said wall.

27. A damper as claimed in claim 26, said rigid piston including a constant volume accumulator chamber wherein said movable valve system provides for a pneumatic flow from said first variable volume chamber into said accumulator chamber when said piston moves in said first direction, and said movable valve system provides for a pneumatic flow from said second variable volume chamber into said accumulator chamber when said piston moves in said opposite second direction.

28. A method of making a pneumatic endstop surface effect damper, said method comprising: providing a piston housing with an inner housing wall defining an inner chamber, providing a rigid pneumatic piston for dividing said piston housing inner chamber into a first variable volume chamber and a second variable volume chamber, providing a pneumatic piston valve system for controlling the pneumatic flow of a gas through said pneumatic piston, providing a surface effect damper elastomeric member for damping a relative motion between said piston housing and said rigid pneumatic piston, assembling said rigid pneumatic piston, said pneumatic piston valve system, and said surface effect damper elastomeric member into said piston housing inner chamber wherein said rigid pneumatic piston is movable in a first direction stroke and an opposite second direction stroke inside said piston housing and along said inner housing wall, said piston dividing said piston housing inner chamber into a first variable volume chamber and a second variable volume chamber with said pneumatic piston valve system actuated by a change in the stroke direction of said piston wherein said valve system releases a pneumatic pressure from said first variable volume chamber when said piston changes from said first direction stroke to said opposite second direction stroke and releases a pneumatic pressure from said second variable volume chamber when said piston changes from said second direction stroke to said first direction stroke, and with said surface effect damper elastomeric member positioned between said housing and said pneumatic piston to inhibit movement of said piston axially along said housing wall with a surface effect damping force.
